(19) United States
(12) Patent Application Publication
(10) Pub. No.: US 2026/0334390 A1
(43) Pub. Date: Oct. 29, 2026

(54) Irrigation Saddle Assembly

(71) Applicant: XCAD Valve and Irrigation, Inc., Paul, ID (US)

(72) Inventors: Don D. Duffin, Paul, ID (US); Roger M. Duffin, Paul, ID (US)

(21) Appl. No.: 19/710,061

(22) Filed: Jun. 16, 2026

Related U.S. Application Data
(63) Continuation of application No. 19/248,228, filed on Jun. 24, 2025.
Application No. 19/248,228 is a continuation of application No. 18/888,902, filed on Sep. 18, 2024, now Pat. No. 12,336,460.

(51) Int. Cl. A01G 25/02; F16L 41/02; F16L 47/34

(52) U.S. Cl. CPC A01G 25/023; F16L 41/021; F16L 47/345

(57) ABSTRACT

An irrigation saddle assembly includes a saddle body configured for attachment to a pipe and a neck portion extending from the saddle body. The neck portion defines a fluid passage therethrough and includes internal threads formed on an interior surface of the neck portion and external threads formed on an exterior surface of the neck portion. In some embodiments, the internal threads and the external threads are formed on opposite sides of a common wall portion of the neck portion. The internal and external threads provide threaded engagement structures for irrigation components. In certain embodiments, the neck portion includes a bore extending therethrough and the internal threads and external threads are integrally formed with the neck portion. The neck portion may be integrally formed with the saddle body.

### CROSS-REFERENCE TO RELATED APPLICATIONS

This application claims the benefit of U.S. Non Provisional application Ser. No. 19/248,228, filed Jun. 24, 2025, which claims benefit to U.S. Non Provisional application Ser. No. 18/888,902, filed Sep. 18, 2024, now U.S. Pat. No. 12,336,460 issued Jun. 24, 2025, which claims the benefit of U.S. Nonprovisional application Ser. No. 15/925,622, filed Mar. 19, 2018, U.S. Pat. No. 12,144,294 issued Nov. 19, 2024, which claims benefit to U.S. Provisional Application No. 62/472,698, filed Mar. 17, 2017 the disclosure of each of which is incorporated by reference.

### FIELD OF THE INVENTION

The present invention relates generally to irrigation systems and irrigation fittings. More particularly, the present invention relates to irrigation saddle assemblies configured for attachment to irrigation pipes and having neck portions that include both internal threads and external threads for receiving threaded irrigation components.

### BACKGROUND OF THE INVENTION

One type of agricultural irrigation system commonly used is a solid set, or fixed grid, system that utilizes movable pipe to provide water to sprinklers spaced throughout all or part of the field. Each pipe contains intermittently spaced pipe couplers with a riser to provide water from the pipe to a sprinkler mounted on top of the riser. Many methods have been used to mount the riser to the pipe coupler more easily to facilitate easier installation and removal, preferably without tools. One more common method is for the pipe coupler to have a pipe coupler saddle (“saddle”) fixedly connected to the pipe coupler for separably mounting a riser adapter, to which the riser is fixedly mounted. The saddle and riser adapter allow for water to flow from the pipe coupler to the riser and sprinkler.

### SUMMARY

The purpose of the Summary is to enable the public, and especially the scientists, engineers, and practitioners in the art who are not familiar with patent or legal terms or phraseology, to determine quickly from a cursory inspection, the nature and essence of the technical disclosure of the application. The Summary is neither intended to define the inventive concept(s) of the application, which is measured by the claims, nor is it intended to be limiting as to the scope of the inventive concept(s) in any way.

In one aspect, an irrigation saddle assembly includes a saddle body configured for attachment to a pipe and a neck portion extending from the saddle body. The neck portion defines a fluid passage therethrough and includes internal threads formed on an interior surface of the neck portion and external threads formed on an exterior surface of the neck portion.

In another aspect, the internal threads and the external threads are formed on opposite sides of a common wall portion of the neck portion. In certain embodiments, the internal threads and the external threads are integrally formed with the neck portion and the neck portion is integrally formed with the saddle body.

In another aspect, an irrigation saddle assembly includes a saddle body configured for attachment to a pipe and a neck portion extending from the saddle body. The neck portion includes a wall portion defining a bore extending through the neck portion. First threads are formed on an inner surface of the wall portion and second threads are formed on an outer surface of the wall portion.

In another aspect, an irrigation saddle assembly includes a saddle body configured for attachment to a pipe and a neck portion extending from the saddle body. Internal threads are formed on an interior surface of the neck portion and are configured to threadedly engage a threaded irrigation component. In certain embodiments, the threaded irrigation component comprises a sprinkler body or a plug.

In another aspect, an irrigation saddle assembly includes a saddle body configured for attachment to a pipe and a neck portion extending from the saddle body. External threads are formed on an exterior surface of the neck portion and are configured to threadedly engage a threaded irrigation component. In certain embodiments, the threaded irrigation component comprises a sprinkler body or a cap.

Still other features and advantages of the presently disclosed and claimed inventive concept(s) will become readily apparent to those skilled in this art from the following detailed description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

### BRIEF DESCRIPTION OF DRAWINGS

FIG. 1 illustrates an exploded isometric view of a first embodiment of an irrigation saddle.

FIG. 2 illustrates an isometric cross-sectional view of a first embodiment of an irrigation saddle.

FIG. 3 illustrates an isometric view of a first embodiment of an irrigation saddle with an exploded riser adapter and seal.

FIG. 4 illustrates a cross-sectional view of a first embodiment of an irrigation saddle with a riser adapter and seal.

FIG. 5 illustrates an exploded isometric view of a second embodiment of an irrigation saddle with a riser adapter and seal.

FIG. 6 illustrates an isometric cross-sectional view of a second embodiment of an irrigation saddle with a riser adapter and seal.

FIG. 7 illustrates an isometric view of a third embodiment of an irrigation saddle with a riser adapter and seal.

FIG. 8 illustrates an isometric cross-sectional view of a fourth embodiment of an irrigation saddle with a riser adapter and seal.

FIG. 9 illustrates a cross-sectional detail view of a fourth embodiment of an irrigation saddle with a riser adapter and seal.

### DETAILED DESCRIPTION OF THE FIGURES

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined in the claims.

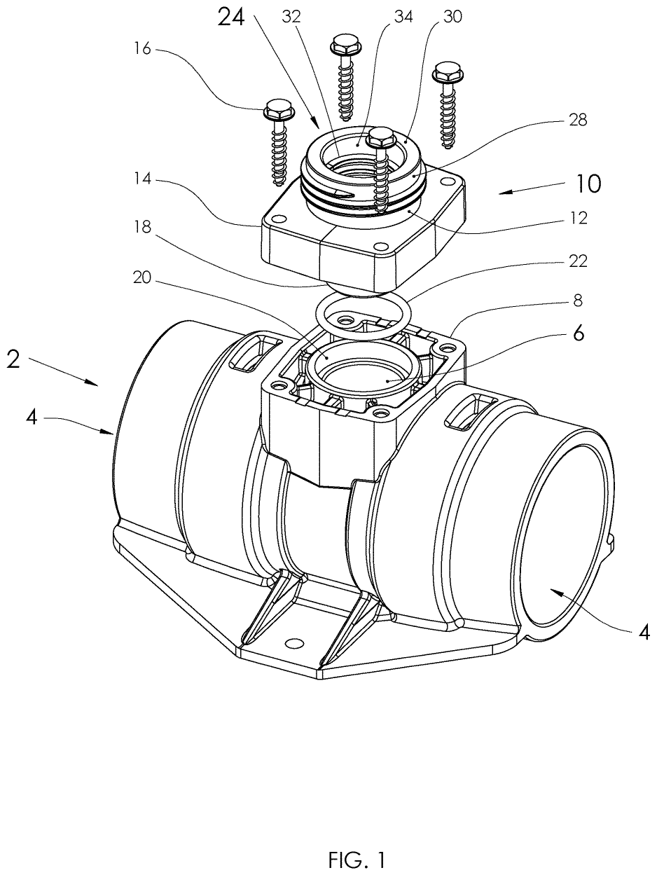

FIGS. 1-3 illustrate a first preferred embodiment of a saddle for use with an irrigation pipe coupler. FIG. 1 illustrates an isometric view of a saddle. The pipe coupler 2 is cylindrical and tube-like in structure and has one or more open ends 4 to which irrigation pipe can be connected. The pipe coupler 2 has an aperture 6 generally at the top. In a preferred embodiment, the pipe coupler 2 has a pipe coupler flange 8 extending from the pipe coupler in a generally vertical direction, surrounding aperture 6. A saddle 10 has a main body 12 with a generally tubular profile. In a preferred embodiment the saddle 10 has a saddle flange 14 that is configured to fixedly mount the saddle 10 to the top of the pipe coupler flange 8 by fasteners 16 or other mechanical mechanism. In this embodiment, the saddle main body 12 has a tubular protrusion 18, and the pipe coupler flange 8 has a circular recess 20 into which the tubular protrusion 18 fits, which circular recess 20 aligns with aperture 6. A saddle body seal 22 is configured to mount between the tubular protrusion 18 and annular recess 20 to prevent leakage at this joint.

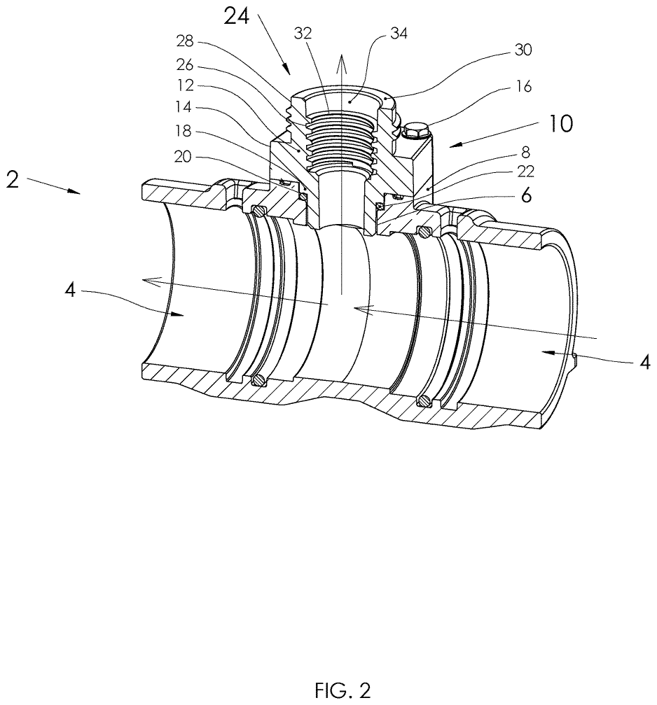

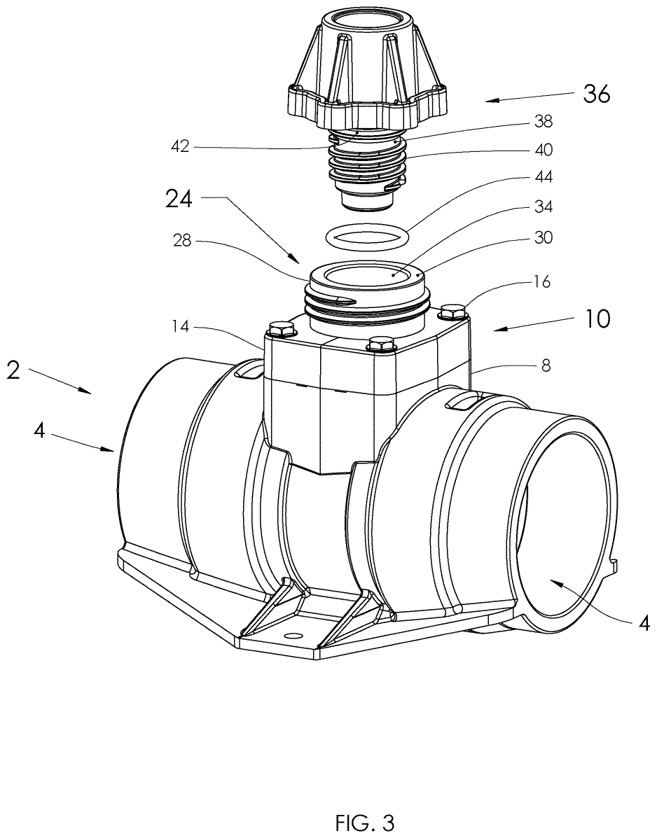

The saddle main body 12 has a circular mount 24 that is tubular in shape and extends away from the saddle in a roughly perpendicular orientation with respect to the ground. The circular mount 24 is positioned above the aperture 6 providing fluid communication between the pipe coupler 2 and circular mount 24. The circular mount 24 has an internal annular face 26 (FIG. 2), an external annular face 28, and an end face 30 positioned at the top of the circular mount 24. The circular mount 24 has internal threads 32 on the internal annular face 26, spaced away from end face 30 to provide an internal annular sealing face 34. The circular mount 24 is configured to threadedly receive a riser adapter 36 (shown in FIG. 3). Irrigation pipe couplers are typically made from plastic. A mountable saddle can be made of other materials, such as metal, to allow for stronger threads on the circular mount 24, eliminating a weak point on the coupler-riser assembly.

FIG. 2 illustrates an isometric cross-sectional view of the saddle 10 fixedly mounted to the pipe coupler 2. The saddle body seal 22 is shown providing a seal between the tubular protrusion 18 and circular recess 20 to prevent leakage at this joint.

FIG. 3 illustrates an isometric view of the first embodiment of an irrigation saddle 10 of FIGS. 1-2 with an exploded riser adapter 36 and dynamic seal 44. In this first preferred embodiment, the riser adapter 36 has a hollow main body that is cylindrical in shape with a base 38 with external circumferential threading 40. The threaded base 38 is configured to be releasably mounted with the internal threading of the circular mount 24. The riser adapter base 38 also has a circumferential channel 42 on the external annular face above the external circumferential threading 40. The circumferential channel 42 is configured to mount a dynamic seal 44, preferably an O-ring. When the riser adapter 36 is threaded into the saddle circular mount 24, pressure from water flowing from the coupler through the riser adapter causes the dynamic seal 44 to radially seal against the internal annular sealing face 34. The dynamic seal radially seals against the internal annular sealing face 36, which is parallel to the mounting direction of the riser adapter 36. Because of this construction, the dynamic seal seals against the annular sealing face 34 even if the riser adapter 36 is not fully threaded into the circular mount 24. In this way, high axial force is not needed to create a leak-free seal, and the riser adapter 36 can be more easily installed without needing to substantially tighten the riser adapter.

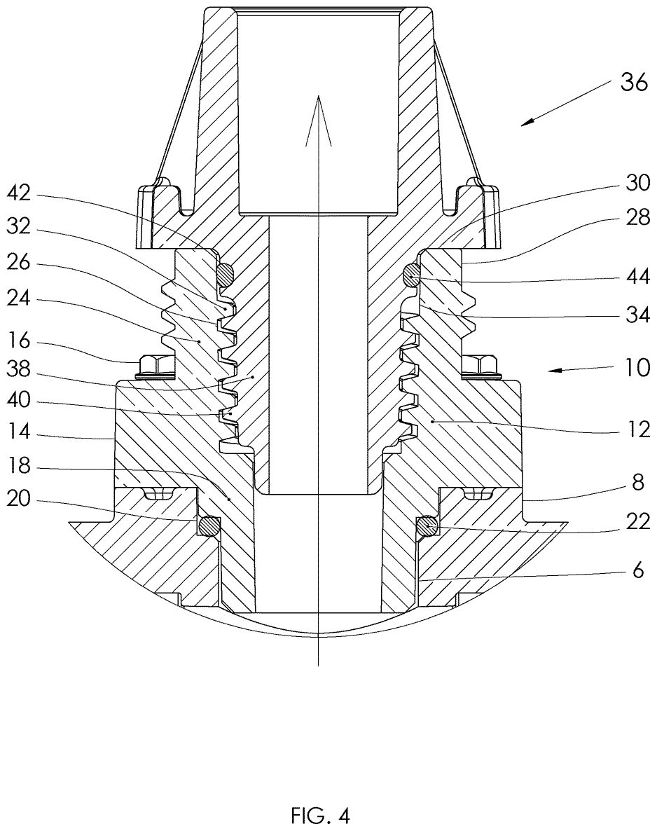

FIG. 4 illustrates a cross-sectional view of a first embodiment of an irrigation saddle 10 with a riser adapter 36 fully installed.

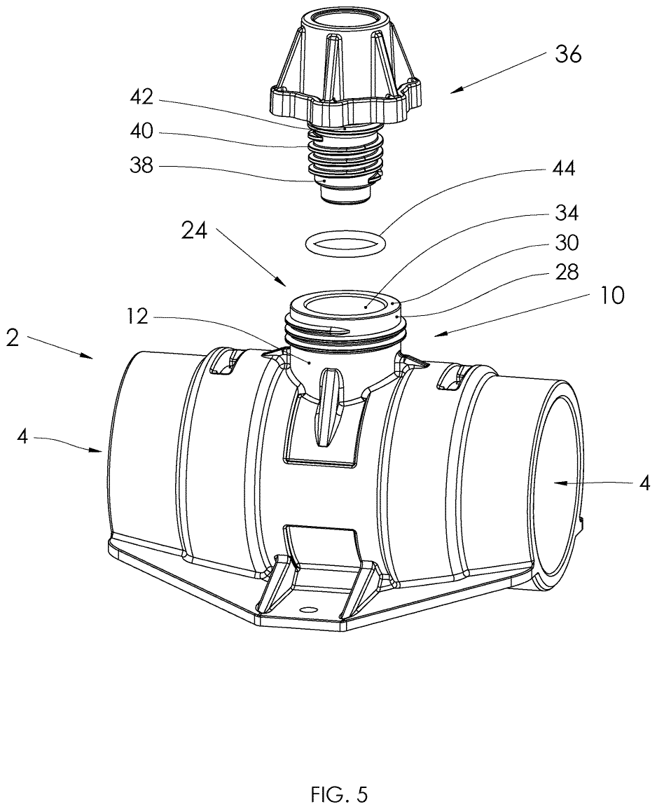

FIG. 5 illustrates an exploded isometric view of a second embodiment of an irrigation saddle 10 with a riser adapter 36 and seal 44. In this preferred embodiment, the saddle 10 is integral with the pipe coupler.

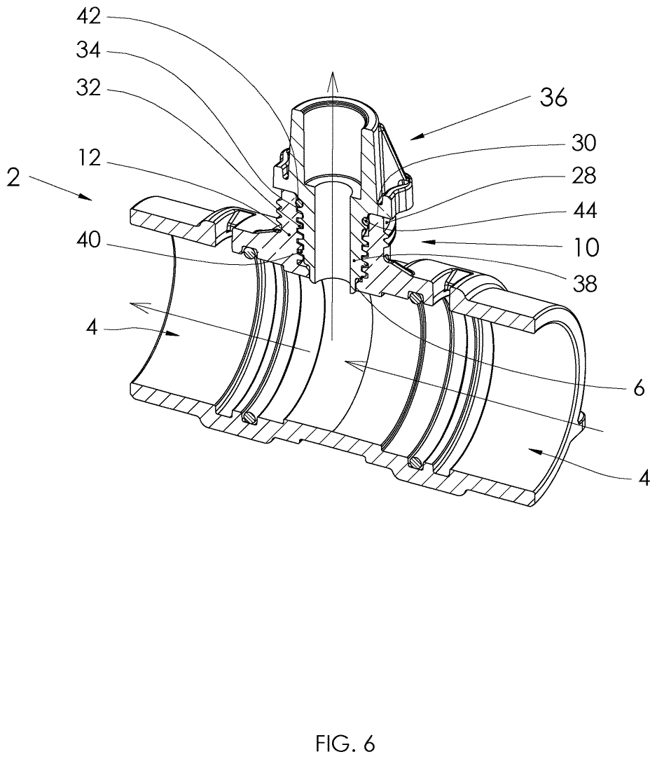

FIG. 6 illustrates an isometric cross-sectional view of a second embodiment of an irrigation saddle 10 with a riser adapter 36 and dynamic seal 44 fully installed. In this preferred embodiment, the riser adapter 36 is configured for fixed engagement with the riser by adhesive or some other method.

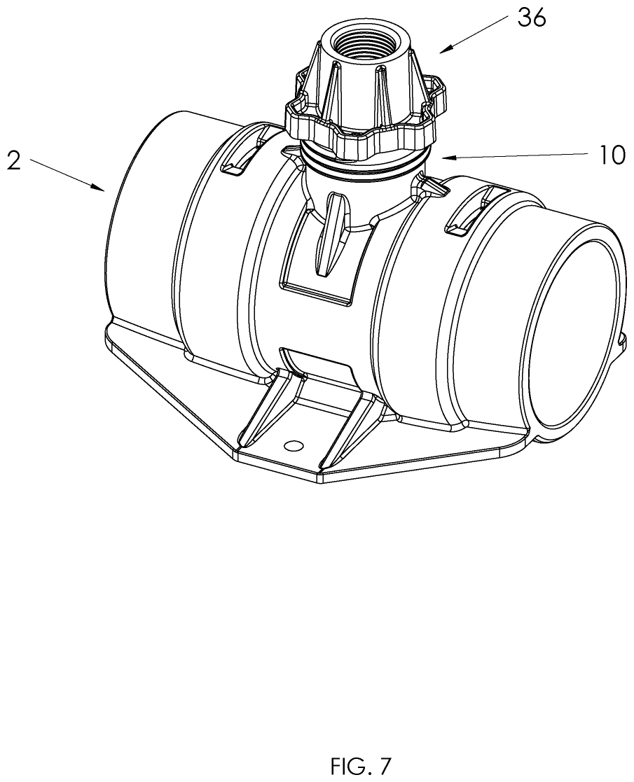

FIG. 7 illustrates an isometric view of a third embodiment of an irrigation saddle with a riser adapter 36 fully installed. In this preferred embodiment, the riser adapter 36 is configured for threadedly engaging with the riser.

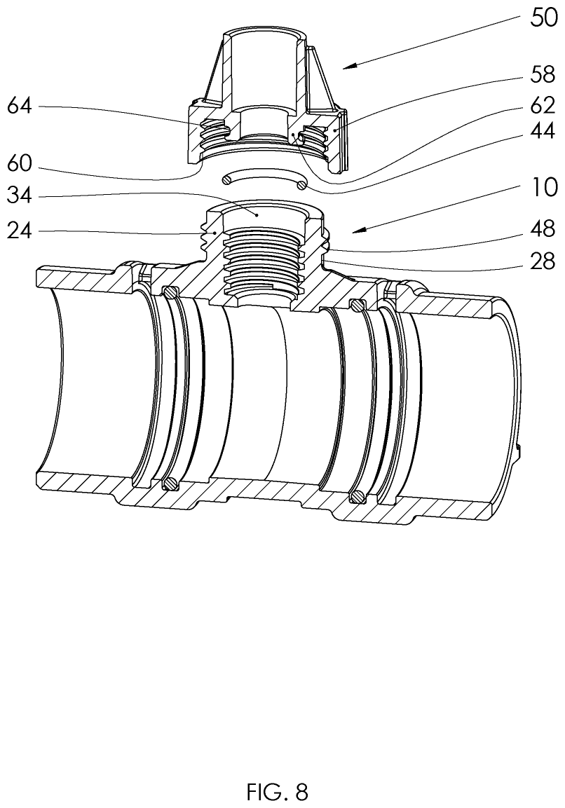

FIG. 8 illustrates an isometric cross-sectional view of a fourth embodiment of an irrigation saddle 10 with a cap-style riser adapter 50 and dynamic seal 44. In this preferred embodiment, the circular mount external annular face 28 also has external threads 48 for engagement with a cap-style riser adapter 50. The riser adapter 50 has a hollow main body that is cylindrical in shape with an annular flange 58. The annular flange 58 has internal threading 60 configured to releasably mount with the circular mount external threading 48. The riser adapter 50 has a hollow main body 62 with a circumferential channel 64 on the exterior face. The circumferential channel 64 is configured to mount a dynamic seal 44, preferably an O-ring. When the riser adapter 50 is threaded onto the saddle circular mount 24, the dynamic seal 44 radially seals against the internal annular sealing face 34.

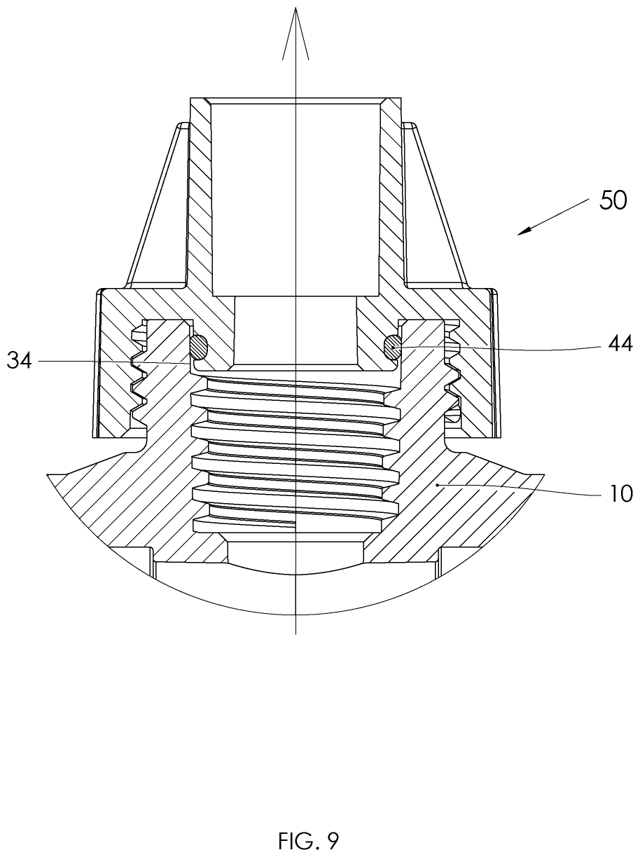

FIG. 9 illustrates a cross-sectional detail view of a fourth embodiment of an irrigation saddle 10 with a riser adapter 50 and dynamic seal 44. The riser adapter 50 is fully installed and the dynamic seal 44 is positioned to radially seal against the annular sealing face 34.

While certain preferred embodiments are shown in the figures and described in this disclosure, it is to be distinctly understood that the presently disclosed inventive concept(s) is not limited thereto but may be variously embodied to practice within the scope of the following claims. From the foregoing description, it will be apparent that various changes may be made without departing from the spirit and scope of the disclosure as defined by the following claims.

What is claimed is:

1. An irrigation saddle assembly comprising:
a saddle body configured for attachment to a pipe;
a neck portion extending from the saddle body and defining a fluid passage therethrough;
internal threads formed on an interior surface of the neck portion; and
external threads formed on an exterior surface of the neck portion.

2. The irrigation saddle assembly of claim 1, wherein the internal threads and the external threads are formed on opposite sides of a common wall portion of the neck portion.

3. The irrigation saddle assembly of claim 1, wherein the internal threads and the external threads are integrally formed with the neck portion.

4. The irrigation saddle assembly of claim 1, wherein the neck portion is integrally formed with the saddle body.

5. The irrigation saddle assembly of claim 1, wherein the internal threads comprise female threads.

6. The irrigation saddle assembly of claim 1, wherein the external threads comprise male threads.

7. The irrigation saddle assembly of claim 1, wherein the neck portion comprises a cylindrical neck portion.

8. The irrigation saddle assembly of claim 1, wherein the external threads surround at least a portion of the internal threads.

9. The irrigation saddle assembly of claim 1, wherein the fluid passage extends through the internal threads.

10. The irrigation saddle assembly of claim 1, wherein the internal threads and the external threads are configured to threadedly engage irrigation components.

11. An irrigation saddle assembly comprising:
a saddle body configured for attachment to a pipe;
a neck portion extending from the saddle body;
a wall portion defining a bore extending through the neck portion;
first threads formed on an inner surface of the wall portion; and
second threads formed on an outer surface of the wall portion.

12. The irrigation saddle assembly of claim 11, wherein the wall portion comprises a cylindrical wall portion.

13. The irrigation saddle assembly of claim 11, wherein the second threads are positioned radially outward of the first threads.

14. The irrigation saddle assembly of claim 11, wherein the bore is configured to fluidly communicate with an opening extending through the saddle body.

15. The irrigation saddle assembly of claim 11, wherein the first threads comprise female threads and the second threads comprise male threads.

16. An irrigation saddle assembly comprising:
a saddle body configured for attachment to a pipe;
a neck portion extending from the saddle body;
internal threads formed on an interior surface of the neck portion;
external threads formed on an exterior surface of the neck portion;
wherein the internal threads are configured to threadedly engage a first threaded irrigation component; and
wherein the external threads are configured to threadedly engage a second threaded irrigation component.

17. The irrigation saddle assembly of claim 16, wherein the first threaded irrigation component comprises a sprinkler body.

18. The irrigation saddle assembly of claim 16, wherein the second threaded irrigation component comprises a cap.

19. The irrigation saddle assembly of claim 16, wherein the external threads are positioned radially outward of the internal threads.

20. The irrigation saddle assembly of claim 16, wherein the internal threads and the external threads are formed on opposite sides of a common wall portion of the neck portion.
